(19) United States
(12) Patent Application Publication
(10) Pub. No.: US 2023/0316096 A1
(43) Pub. Date: Oct. 5, 2023

(54) METHOD AND A SYSTEM FOR OPTIMALLY DISPLAYING A KNOWLEDGE GRAPH

(71) Applicants: Dagnachew Birru, (US); Vishal Vaddina, (US); Somil Shah, (US); Kenneth Rebello, (US)

(72) Inventors: Dagnachew Birru, (US); Vishal Vaddina, (US); Somil Shah, (US); Kenneth Rebello, (US)

(73) Assignee: Quantiphi, Inc, Marlborough, MA (US)

(21) Appl. No.: 18/205,577

(22) Filed: Jun. 5, 2023

(51) Int. Cl. G06N 5/02

(52) U.S. Cl. CPC G06N 5/02

(57) ABSTRACT

The disclosure provides a system, a method, and a computer program product for displaying a a Knowledge Graph at a client device. The method comprises receiving a sequence of selection elements in the Knowledge Graph, by a user. The method may include displaying the sequence of selected elements in a last in, first out order on selecting a UI component by the user. Also, the method may enable saving a state of display on closing display of the Knowledge Graph. Further, on reopening the display of the Knowledge Graph the saved state is rendered. The method also provides box select and panning feature for visually manipulating the Knowledge Graph. Further, in order to optimally execute the above features, nodes and edges which are the elements of a Knowledge Graph are stored in array data structures.

The present disclosure relates to a Knowledge Graph and more particularly relates to systems and methods for optimally displaying a Knowledge Graph. This application is related to the U.S. application Ser. No. 18/128,343 whose contents are herein incorporated by reference in its entirety.

### TECHNOLOGICAL FIELD

### Background

A knowledge graph is a type of knowledge base that stores information in a way that represents the relationships between different concepts, entities, and data points. It is designed to enable users to better understand the meaning and context behind data, enabling users to make more accurate and informed decisions.

In a knowledge graph, data is organized into nodes and edges, where nodes represent entities or concepts, and edges represent the relationships between them. For example, a knowledge graph might include nodes for people, places, and things, with edges representing the relationships between them, such as “works at”, “lives in”, or “is a type of”.

There is a preference for alternative navigation paradigm in the medical space especially after the COVID-19 pandemic for such a Knowledge Graph. All the articles, specifically scholarly publications, can be organized as a Knowledge Graph.

Further the Knowledge Graph must provide an easily navigable visual interface. A user with the help of the interface can get an overall picture of the knowledge domain, understand the relationships between concepts and navigate to the right information. And this saves a lot of time and effort for the user. Further, this will be of immense benefit to the scientific community.

Therefore, there is a need for improved systems and methods for optimally displaying a Knowledge Graph. Specifically, there is a need to retrace the navigation selection by a user.

Also, there is a preference for visual rendering of the elements of the Knowledge Graph aesthetically. Further, there are basic requirements of preserving the state of display, panning, and box select in a Knowledge Graph.

### BRIEF SUMMARY

Example embodiments of the present disclosure provide a system, a method, and a computer program product for implementing a process of optimally displaying a Knowledge Graph in order to overcome the challenges discussed above, to provide the solutions envisaged as discussed above.

A system, a computer-implemented method and a computer programmable product are provided for displaying a Knowledge Graph.

Some example embodiments disclosed herein provide a computer-implemented method and computer programmable product for implementing a process of displaying a Knowledge Graph. The computer-implemented method comprises receiving a selection of a first element by a user, in the Knowledge Graph. The method may include receiving a selection of a second element by the user, in the Knowledge Graph. The method may further include providing a user interface (UI) component. Finally, the method may include displaying the first element on selecting the UI component by the user.

According to some example embodiments, the computer-implemented method further comprising occluding the second element.

According to some example embodiments, the computer-implemented method further comprising receiving selection of a third element and a fourth element by the user, in the knowledge graph.

According to some example embodiments, the computer-implemented method further comprising displaying the first element, the second element, the third element and the fourth element, on selecting the UI component in reverse order of selection.

According to some example embodiments, the computer-implemented method further comprising saving a state of display of the knowledge graph on closing display of the Knowledge Graph.

According to some example embodiments, the elements comprise nodes and edges.

According to some example embodiments, the nodes are stored in a first array and the edges are stored in a second array.

According to some example embodiments, the computer-implemented method further comprising allocating a first weight, a second weight, and a third weight to the first element, the second element and the third element respectively of the Knowledge Graph, wherein the first weight is lesser than the second weight and the third weight is greater than the second weight. The method may include displaying the first element, the second element and the third element, wherein display distance between the first element and the second element is greater than display distance between the first element and the third element.

According to some example embodiments, the computer-implemented method further comprising restarting the display of the Knowledge Graph and rendering the saved display of the Knowledge Graph.

According to some example embodiments, the computer-implemented method further comprising saving elements of the Knowledge Graph in at least two arrays.

According to some example embodiments, the elements comprise nodes and edges.

According to some example embodiments, the nodes are stored in a first array and the edges are stored in a second array.

According to some example embodiments, the computer-implemented method further comprising allocating a first weight, a second weight, and a third weight to the first element, the second element and the third element respectively of the Knowledge Graph, wherein the first weight is lesser than the second weight and the third weight is greater than the second weight. The method may further include displaying the first element, the second element and the third element, wherein display distance between the first element and the second element is greater than display distance between the first element and the third element.

According to some example embodiments, the computer-implemented method further comprising enabling the user to pan the Knowledge Graph during display.

According to some example embodiments, the computer-implemented method further comprising providing a box select tool that allows the user to select a subset of elements and hide rest of elements of the Knowledge Graph.

In one aspect, a system for displaying a Knowledge Graph at a client device is disclosed. The system comprises at least a processor and computer executable instructions, that when executed by the hardware processor, cause the system to display Knowledge Graph comprising displaying a Knowledge Graph. The at least one processor is further configured to receiving a selection of a first element by a user, in the Knowledge Graph. Further, the at-least a processor is configured to receiving a selection of a second element by the user, in the Knowledge Graph. Also, the at least one processor is configured to providing a user interface (UI) component. The at least one processor is further configured to displaying the first element on selecting the UI component by the user.

In yet another aspect, a computer program product comprising a non-transitory computer readable medium having stored thereon computer executable instructions which when executed by at least one processor, cause the processor to carry out operations for displaying a Knowledge Graph.

The operations further comprise receiving a selection of a first element by a user, in the Knowledge Graph.

The operations further comprise receiving a selection of a second element by the user, in the Knowledge Graph.

The operations further comprise providing a user interface (UI) component.

The operations further comprise displaying the first element on selecting the UI component by the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a display of a Knowledge Graph with a sequence of elements selected by a user, with an example embodiment;

FIG. 2 illustrates a block diagram of an electronic circuitry for displaying a Knowledge Graph, in accordance with an example embodiment;

FIG. 3 illustrates a highlight button rendering element selection of a Knowledge Graph in a reverse order, in accordance with an example embodiment;

FIG. 4 illustrates a flow diagram of a method for displaying a Knowledge Graph, in accordance with an example embodiment;

FIG. 5 shows saving display state after closing a display of the Knowledge Graph, in accordance with an example embodiment;

FIG. 6 illustrates rendering the saved display state of the Knowledge Graph after reopening, in accordance with an example embodiment;

FIG. 7 illustrates a flow diagram of a method for saving state of display of the Knowledge Graph and rendering the saved state when reopened, in accordance with an example embodiment;

FIG. 8 illustrates two arrays to store nodes and edges of the Knowledge Graph, in accordance with an example embodiment;

FIG. 9 illustrates a flow diagram of a method for saving and storing nodes and edges of a Knowledge Graph in arrays, in accordance with an example embodiment;

FIG. 10 shows a display of nodes and edges in a Knowledge Graph in an aesthetic manner, in accordance with an example embodiment;

FIG. 11 shows a flow diagram for displaying nodes and edges of a Knowledge Graph in an aesthetic manner, in accordance with an example embodiment;

FIG. 12 shows a display of the Knowledge Graph with panning, in accordance with an example embodiment;

FIG. 13 shows a flow diagram of a method for enabling a user to pan the Knowledge Graph during display, in accordance with an example embodiment;

FIG. 14 illustrates a box select tool of the Knowledge Graph, in accordance with an example embodiment;

FIG. 15 illustrates the operation of the box select tool of the Knowledge Graph by selecting the nodes within the box and hiding the nodes outside the box, in accordance with an example embodiment;

FIG. 16 shows a flow diagram of a method for providing a box select tool that allows the user to select node, in accordance with an example embodiment;

The features and advantages of the present invention will become more apparent from the detailed description set forth below when taken in conjunction with the drawings, in which reference characters identify corresponding elements throughout. In the drawings, like reference numbers generally indicate identical, functionally similar, and/or structurally similar elements.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The Knowledge Graph is a type of graph knowledge base that is designed to store and represent knowledge in a structured and organized way. An Entity-Relation model is used for a Knowledge Graph. Thereby, it is a collection of entities, which can be anything from people and places to concepts and ideas, and the relationships between those entities. Further, Knowledge Graphs are used to power search engines, chatbots, recommendation systems, and other applications that require intelligent information retrieval and processing.

At the heart of a Knowledge Graph is a set of nodes, each representing an entity, and a set of edges, each representing a relationship between entities. Nodes can have attributes such as labels, descriptions, and types that provide additional information about the entity they represent. Edges can also have attributes that describe the relationship between the entities they connect.

One of the defining characteristics of a Knowledge Graph is its ability to model complex relationships between entities. In an example embodiment, a Knowledge Graph could represent the relationship between a drug, its formula, and the target disease. The drug node would be connected to a formula node by a “represented by” edge. Further, the drug node would be connected to the disease node by a “targets” edge. By representing relationships in this way, a Knowledge Graph can capture the nuances of real-world knowledge in a structured and easily queryable form.

Another key feature of a Knowledge Graph is its ability to be extended and updated as new information becomes available. Nodes and edges can be added or modified as needed, allowing the graph to evolve over time and adapt to changing requirements. This makes Knowledge Graphs particularly useful for applications that require up-to-date information, such as scientific or real-time search.

In an example embodiment, due to the COVID-19 pandemic, many leading research groups have come together to create the COVID-19 Open Research Dataset (CORD-19). CORD-19 is a resource of over a million scholarly articles, including over 400,000 with full text, about COVID-19, SARS-CoV-2, and related coronaviruses. This open-source data-set is available to the global research community to experiment with and apply recent advances in natural language processing and other Artificial Intelligence (AI) techniques. Further, the open-source dataset is used to create a Knowledge Graph.

Creating a knowledge graph for such a large corpus of scientific literature involves several steps.

A first step is to collect scientific literature data from various sources such as academic databases, digital libraries, or repositories. This data can include research papers, patents, reports, and conference proceedings. In an example embodiment the knowledge source is the scholarly articles about COVID-19 and variants.

The next step is to extract relevant information from the collected data. This can be done using natural language processing (NLP) techniques such as named entity recognition, relation extraction, and topic modelling. The said techniques are used to identify entities such as authors, organizations, locations, and scientific concepts. Relation extraction is used to identify the relationships between entities, such as co-authorship, citation, association, or funding etc. Topic modelling is used to identify the main topics and themes of the literature.

Once the relevant information is extracted, it needs to be integrated into a Knowledge Graph. In an example embodiment, graph data is generated by the CORD Knowledge Graph ML models, in the form of nodes & edges or in the form of triplets (consisting of a subject, object and relation). This data is curated into a suitable format for the graph library which is used to render the graph for use in the application.

Different types of Knowledge Graphs may be generated as mentioned below.

In an example embodiment a Document Knowledge Graph is generated. This graph consists of all the entities within a document, color coded by their subtypes. Every entity is connected to one or more other entities, forming triplets which correspond to sentences sourced from the documents. These triplets are formed following a curated triplet-extraction process using Machine Learning systems. Every triplet consists of a subject, object (nodes) and relation (edge).

In a second example embodiment a Document-to-Document Knowledge Graph is generated. This graph displays all the metadata concerning a particular document. It comprises the document's authors, the journals it was published in, the year of publishing and certain significant entities that were present in the document. It further adds other documents that might have any of the above-mentioned details in common with the selected document. Documents suggested for further reading are highlighted in a different color while rendering.

In a third example embodiment Comprehensive Knowledge Graph may be generated. This graph represents the entire dataset comprising of all the research papers. Nodes are made up of documents along with their authors and entities mentioned within them. To add another layer of abstraction, each entity is connected to a concept node which represents the subtype of the entity. This in turn is connected to concept type nodes which represent the type that the subtype belongs to. Like the Document Knowledge Graph, entities are connected to each other to form sentence triplets. Documents are connected by references, while authors are connected by collaborations.

The Knowledge Graph needs to be validated to ensure that the extracted information is accurate and complete. This can be done using manual or automated methods, such as expert review or data quality checks.

In summary, creating a knowledge graph for scientific literature requires a combination of human expertise and advanced technologies. It may provide valuable insights and facilitate the discovery of new scientific knowledge. The modelling of a knowledge graph as an entity relationship involves the below mentioned steps.

Define the entities by identifying the entities that will be part of the knowledge graph. Entities can be anything from people, places, and things to abstract concepts, events, and processes.

Define the relationships by identifying the relationships that exist between the entities. Relationships may be of different types, such as but not limited to “is a”, “part of”, “located in”, “causes”, “belongs to”, “has”, etc.

Define the properties by identifying the properties that describe the entities and relationships. Properties are the attributes or characteristics of an entity or relationship, such as the name, type, description, date, location, etc.

Creating a schema that defines the entities, relationships, and properties, and how they are related to each other. The schema serves as a blueprint for the knowledge graph and ensures consistency and coherence in the data.

Populate the Knowledge Graph with data by adding nodes for the entities, edges for the relationships, and attributes for the properties.

In an embodiment, the Knowledge Graph may be visually explored through the displayed nodes and edges.

Optionally a query language may be used to query the Knowledge Graph and retrieve the information needed. Queries can be simple or complex and can involve multiple entities and relationships.

Extracting an Entity Relation model from natural language involves identifying the relevant entities and their relationships within the text. Mentioned below are some general steps that can be followed to accomplish this in an example embodiment.

The initial step is to identify the relevant entities in the text. Entities can be anything from people, places, organizations, products, to events or concepts. These entities can be identified using Named Entity Recognition techniques, which are commonly used in natural language processing.

After identifying entities, the next step is to determine the relationships between them. Relationships can be of different types such as temporal, spatial, causal, or semantic. These relationships can be inferred from the text by analyzing the verbs, prepositions, and other connecting words.

Once the entities and relationships have been identified, create a graph that represents the Entity Relation model. Each entity can be represented as a node, and each relationship can be represented as a directed edge connecting two nodes.

Finally, refine the Entity Relation model by checking for consistency, completeness, and accuracy. Ensure that all the relevant entities and relationships have been included in the model, and that the relationships are correctly represented.

Further, the knowledge graph needs to be visualized to make it accessible and understandable for end-users. This can be done using various visualization techniques, such as network graphs, heat maps, or semantic maps.

Although any of the mentioned visualization techniques may be used, in an example embodiment we use network graphs.

A visualization of a knowledge graph using a network graph is a graphical representation of the relationships between entities in the graph. A network graph is a type of visualization that displays the nodes and edges of a graph as points and lines, respectively.

In a knowledge graph, the nodes represent entities, while the edges represent the relationships between these entities. Further, to create a network graph visualization of a knowledge graph, the nodes and edges are typically represented as circles and lines, respectively. The circles may be sized and colored based on their attributes, such as the number of connections they have or the type of entity they represent. The lines may also be colored and labelled based on the type of relationship they represent.

The network graph visualization can be interactive, allowing users to zoom in and out, hover over nodes to see their attributes, and filter the graph based on various criteria. This can make it easier to explore and analyze the knowledge graph and identify patterns and insights.

Overall, a visualization of a knowledge graph using a network graph can be a powerful tool for communicating complex information and facilitating data-driven decision-making.

A user may use several techniques to interact with the visualization. Some of the techniques which are used and are not limited to are mentioned below.

In an example embodiment, one way to visually explore a network graph is to highlight specific nodes or edges based on certain criteria, such as their degree centrality, betweenness centrality, or community membership. This can help to identify the most important or influential nodes and edges in the graph.

In an another example embodiment a network graph is explored by filtering the nodes and edges based on specific criteria, such as their type, attribute values, or connectivity. This can help to focus on specific subsets of the graph and reveal patterns and insights that might be hidden in the overall structure.

In an example embodiment, an interactive visualization can enable users to explore the network graph in real-time, by allowing them to zoom in and out, pan, and select nodes and edges. This can make it easier to identify patterns and relationships in the graph and to generate insights.

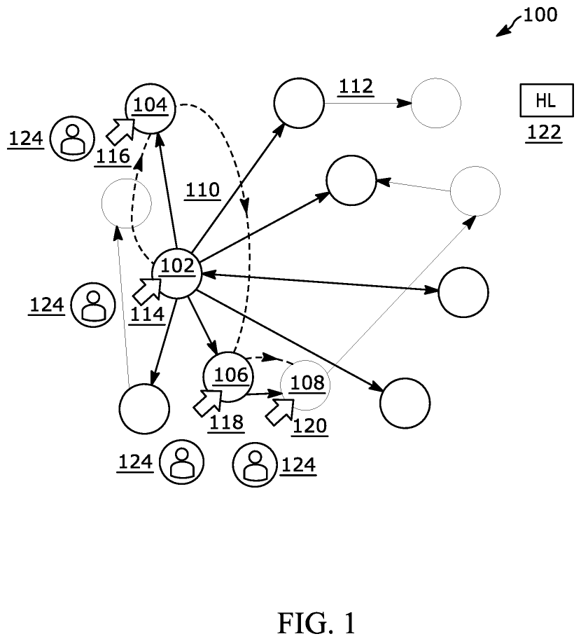

FIG. 1 illustrates a display of a Knowledge Graph with a sequence of elements selected by a user. A display 100 of a Knowledge Graph with nodes 102, 104, 106, and 108 is provided. The edges 110 and 112 of the Knowledge Graph are connected to the nodes 102, 104, 106 and 108. In an example embodiment, a user 124 selects the nodes 102, 104, 118 and 108, respectively. A user using a pointing device makes selection of 114, 116, 118 and 120, respectively. Further, a user interface (UI) component, highlight 122 is presented to the user.

In an example embodiment, UI component highlight is a button. Buttons are graphical elements that are typically rectangular in shape and display text or an icon to indicate their function.

Using buttons, users may interact with the system by clicking or tapping on buttons to perform actions, navigate to different screens, or input data. Buttons can be arranged in various layouts and can have different sizes, colors, and styles to provide visual cues and feedback to users.

Buttons are commonly used in a wide range of software applications, including mobile apps, web apps, desktop software, and video games. They are often used in combination with other UI elements such as text fields, checkboxes, and drop-down menus to provide a comprehensive user interface.

The selection UI may not be limited to button there are several alternatives.

There are several alternatives to button that may be used in software applications or systems.

Gesture-based interfaces: In a gesture-based interface, users interact with the system through hand or body gestures, rather than physical buttons. This type of interface is often used in mobile devices, such as smartphones or tablets, and may enable intuitive and natural interactions.

Voice-based interfaces: Voice-based interfaces use speech recognition technology to enable users to interact with the system through voice commands. This type of interface is often used in virtual assistants, smart home devices, and other applications where hands-free interactions are desirable.

Touch-based interfaces: A touch-based interface uses touchscreens or trackpads to enable users to interact with the system. This type of interface is common in mobile devices, laptops, and tablets.

Menu-based interfaces: In a menu-based interface, users navigate through a series of menus and submenus to perform actions or access different features. This type of interface is often used in complex software applications and may help organize a large number of options and functions.

Natural user interfaces: Natural user interfaces aim to provide a more intuitive and natural way for users to interact with the system. This may include a combination of gesture-based, voice-based, and touch-based interfaces, as well as other input methods such as motion sensors or eye-tracking technology.

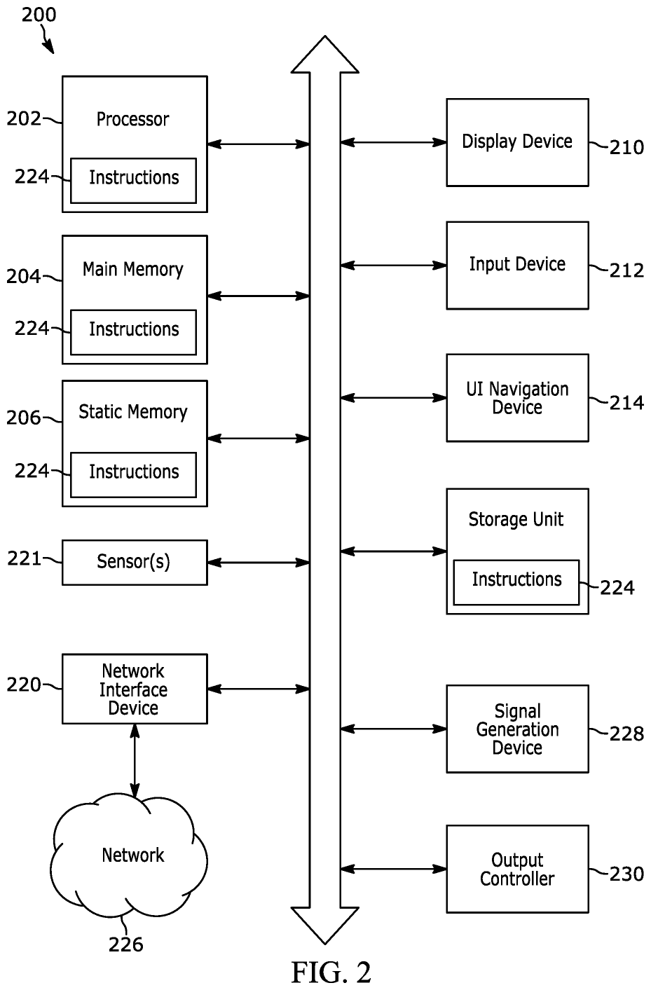

FIG. 2 illustrates a representative machine architecture suitable for implementing the systems and so forth or for executing the methods of displaying a Knowledge Graphs disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 200 includes at least one processor 202 (e.g., a central processing unit (CPU), a graphics processing unit (GPU), advanced processing unit (APU), or combinations thereof), one or more memories such as a main memory 204, a static memory 206, or other types of memory, which communicate with each other via link 208. Link 208 may be a bus or other type of connection channel. The machine 200 may include further optional aspects such as a graphics display unit 210 comprising any type of display. The machine 200 may also include other optional aspects such as an alphanumeric input device 212 (e.g., a keyboard, touch screen, and so forth), a user interface (UI) navigation device 214 (e.g., a mouse, trackball, touch device, and so forth), a storage unit 216 (e.g., disk drive or other storage device(s)), a signal generation device 218 (e.g., a speaker), sensor(s) 221 (e.g., global positioning sensor, accelerometer(s), microphone(s), camera(s), and so forth), output controller 228 (e.g., wired or wireless connection to connect and/or communicate with one or more other devices such as a universal serial bus (USB), near field communication (NFC), infrared (IR), serial/parallel bus, etc.), and a network interface device 220 (e.g., wired and/or wireless) to connect to and/or communicate over one or more networks 226.

Executable Instructions and Machine-Storage Medium

The various memories (i.e., 204, 206, and/or memory of the processor(s) 202) and/or storage unit 216 may store one or more sets of instructions and data structures (e.g., software) 224 embodying or utilized by any one or more of the methodologies or functions described herein. These instructions, when executed by processor(s) 202 cause various operations to implement the disclosed embodiments.

Example Machine Architecture and Machine-Readable Medium

FIG. 2 illustrates a representative machine architecture suitable for implementing the systems and so forth or for executing the methods disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

Signal Medium

The term “signal medium” shall be taken to include any form of modulated data signal, carrier wave, and so forth. The term “modulated data signal” means a signal that has one or more of its characteristics set or changed in such a matter as to encode information in the signal.

Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, el all) etc.).

As used herein, the term “computing device” may refer to a mobile phone, a personal digital assistance (PDA), a tablet, a laptop, a computer, VR Headset, Smart Glasses, projector, or any such device capable of rendering the Knowledge Graph.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

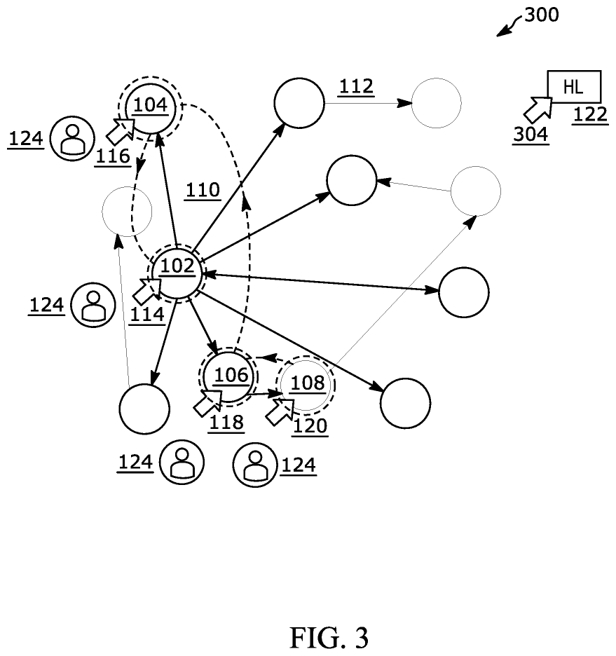

FIG. 3 illustrates a highlight button rendering element selection of a Knowledge Graph in a reverse order. Further FIG. 3 is a temporal successor of FIG. 1, after the user has selected the highlight UI component 122 using an interface 304. The user 124 selected elements 102, 104, 106 and 108 of the Knowledge Graph are displayed in a reverse order 302 in a last-in first-out manner. The display sequence would be elements 108, 106, 104 and 102, which is the reverse order of selection as per FIG. 1.

The data structure that allows last in first out (LIFO) access is a stack. A stack is an abstract data type that represents a collection of elements, with two main operations: push and pop.

The push operation adds an element to the top of the stack, while the pop operation removes the element from the top of the stack. Since the last element added is always at the top of the stack, it will be the first element to be removed when a pop operation is performed.

Stacks are commonly used in programming for tasks such as tracking function calls or keeping track of the order of operations in an expression. They can be implemented using an array or a linked list data structure.

In other embodiments, several other data structures may be used.

A linked list is a data structure that consists of a sequence of nodes, each containing an element and a reference to the next node. Unlike arrays, linked lists can be resized easily and efficiently, but they do not support random access to elements.

A hash table is a data structure that uses a hash function to map keys to an array index, allowing constant time access to elements. Hash tables are commonly used for associative arrays, where keys are associated with values.

A tree is a hierarchical data structure consisting of nodes connected by edges. Trees are often used to represent hierarchical relationships between elements, such as in file systems or organizational charts.

A heap is a data structure that maintains a partially ordered binary tree, where the parent nodes are always greater (or less) than their children nodes. Heaps are often used for priority queues, where elements are ordered by a priority value.

The choice of data structure depends on the specific requirements of the application, such as the desired access time, memory usage, and the type of operations that will be performed.

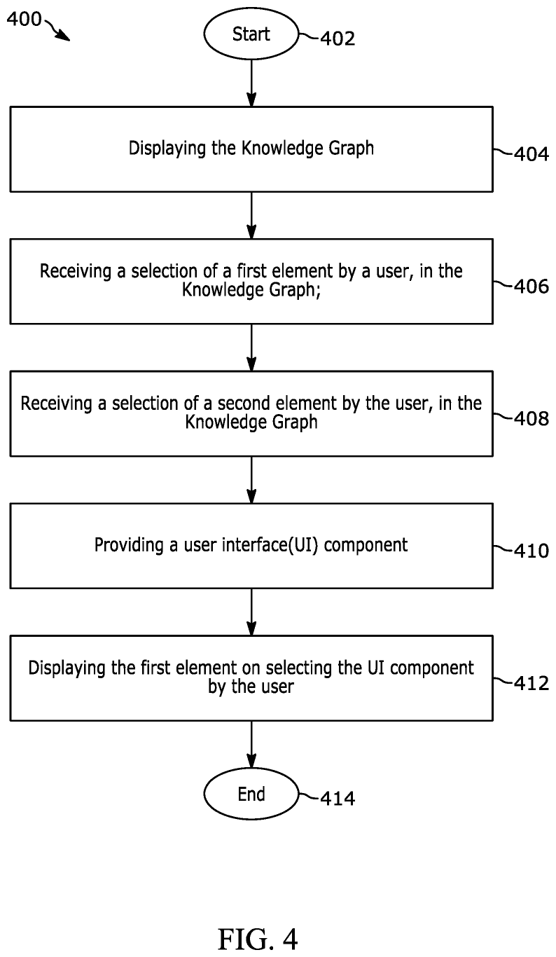

FIG. 4 illustrates a flow diagram of a method 400 for displaying a knowledge graph. It will be understood that each block of the flow diagram of the method 400 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 400 illustrated by the flowchart diagram of FIG. 4 is displaying a Knowledge Graph. Fewer, more, or different steps may be provided.

The Knowledge Graph is displayed at step 404 for enabling the user selection. In the subsequent step 406 a client device receives a selection of a first element from the user.

At step 408 the client device receives a selection of a second element from the user.

A user interface component highlight is provided to the user at step 410 selects a highlight button 122 as mentioned in relation with FIG. 1.

At step 412, the first selected element is displayed.

In a preferred embodiment, the second selected element is occluded.

In another embodiment a third and a fourth elements are selected by the user. On selecting the highlight button, the selected elements are displayed in a reverse order.

In an embodiment selecting may be clicking on an element for example 102, 104 as mentioned in FIG. 1.

In some example embodiments, a computer programmable product may be provided. The computer programmable product may comprise at least one non-transitory computer-readable storage medium having stored thereon computer-executable program code instructions that when executed by a computer, cause the computer to execute the method 400.

In an example embodiment, an apparatus for performing the method 400 of FIG. 4 above may comprise a processor (e.g., the processor 202) configured to perform some or each of the operations of the method 400. The processor may, for example, be configured to perform the operations (402-414) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (402-414) may comprise, for example, the processor 202 which may be implemented in the system 200 and/or a device or circuit for executing instructions or executing an algorithm for processing information as described above.

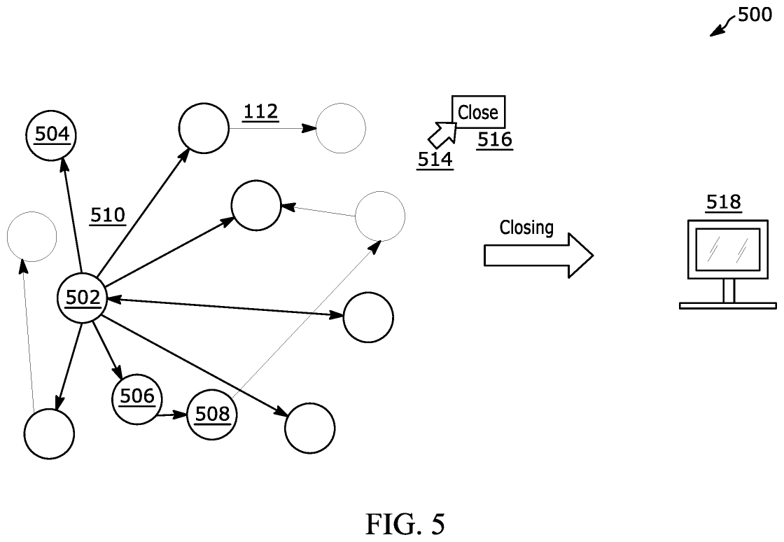

FIG. 5 illustrates a saving display state after closing a display of the Knowledge Graph. The closing display 516 using an interface 514. and state of display is saved after closure 518.

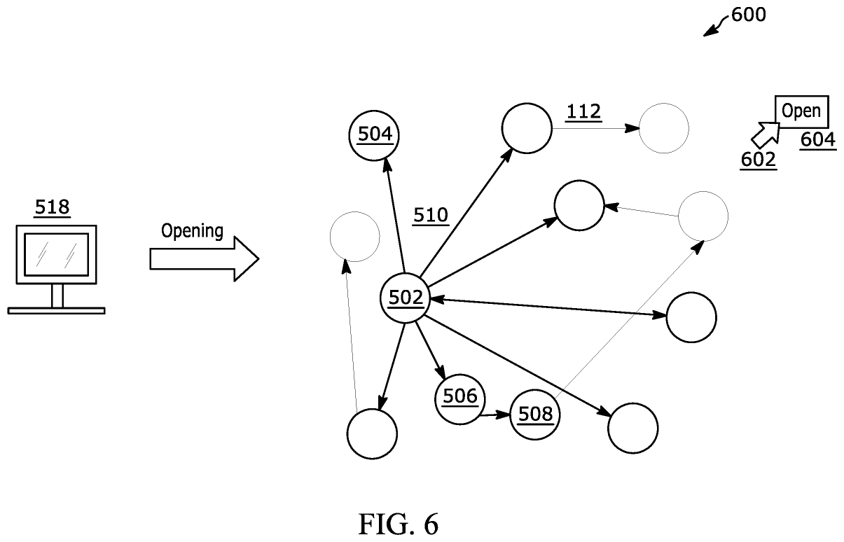

FIG. 6 illustrates rendering the saved display state of the Knowledge Graph after reopening. The display state is saved after closing a display of the Knowledge Graph. Further, opening of a Knowledge Graph results in an accurate rendering of the saved state of display.

The display state of a Knowledge Graph refers to the way the graph is currently visualized or displayed, including its layout, styling, and user interactions. Saving the display state of a Knowledge Graph may allow users to resume work later or to share a particular view of the graph with others.

Below are some possible ways to save the display state of a Knowledge Graph.

Save the state as a configuration file: The display state may be saved as a configuration file that contains all the relevant information about the graph layout, styling, and user interactions. This file may be loaded later to restore the display state.

Save the state as a URL parameter: The display state may be encoded as URL parameters and added to the graph URL. When the URL is opened later, the display state may be automatically loaded.

Save the state as a user preference: If the Knowledge Graph is part of a larger application, the display state may be saved as a user preference. This allows users to customize their experience and have the graph displayed in their preferred way every time they use the application.

Save the state as a session variable: If the Knowledge Graph is used in a web application, the display state may be saved as a session variable. This allows users to navigate to different pages of the application and return to the graph with its previous display state intact.

The choice of method depends on the specific requirements of the application and the desired level of persistence of the display state.

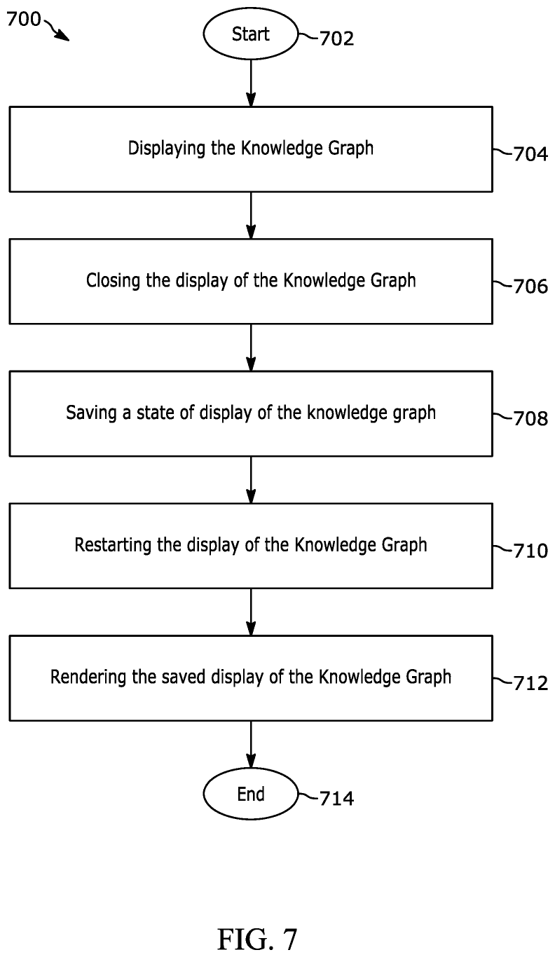

FIG. 7 illustrates flow diagram of a method 700 for saving state of display of the Knowledge Graph and rendering the saved state when reopened. It will be understood that each block of the flow diagram of the method 400 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 700 illustrated by the flowchart diagram of FIG. 7 is saving state of display of the Knowledge Graph and rendering the saved state when reopened. Fewer, more, or different steps may be provided.

The method 700 starts at step 702. At step 704 the method 700 displays the Knowledge Graph. A step 706 The method 700 closes the display of the Knowledge graph. At step 708 the state of display is saved when the display is closed at step 706.

At the penultimate step 712, the method 700 comprises rendering accurately the display of the Knowledge Graph on restarting the display of the Knowledge Graph at step 710.

In an example embodiment, saving the display state of a Knowledge Graph after closing and accurately rendering it on opening, may be accomplished by the steps below.

Identify the state information to save: The display state of a Knowledge Graph typically includes information about the graph layout, styling, and user interactions. The user needs to identify which state information the user wants to save and restore the display state later.

Serialize the state information: The state information needs to be serialized into a format that may be saved, such as a JSON object or XML, file. This may be done using a programming language or library that supports serialization.

Store the serialized state information: The serialized state information needs to be stored somewhere where it may be retrieved later. This may be done using a database, file system, or cloud storage service, depending on user's application's requirements.

Retrieve the serialized state information: When the Knowledge Graph is opened again, the serialized state information is retrieved from the storage location where it was saved.

Deserialize the state information and apply it to the graph: Once the serialized state information is retrieved, it is u deserialized and applied to the graph to restore the display state. This may be done using a programming language or library that supports deserialization and rendering of the graph.

In some example embodiments, a computer programmable product may be provided. The computer programmable product may comprise at least one non-transitory computer-readable storage medium having stored thereon computer-executable program code instructions that when executed by a computer, cause the computer to execute the method 700.

In an example embodiment, an apparatus for performing the method 700 of FIG. 7 above may comprise a processor (e.g., the processor 202) configured to perform some or each of the operations of the method 700. The processor may, for example, be configured to perform the operations (702-714) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (702-714) may comprise, for example, the processor 201 which may be implemented in the system 200 and/or a device or circuit for executing instructions or executing an algorithm for processing information as described above.

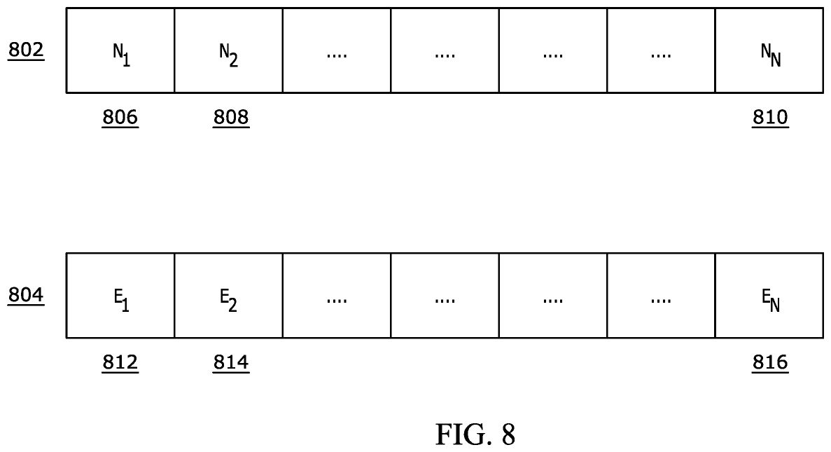

FIG. 8 illustrates two arrays to store nodes and edges of the Knowledge Graph. FIG. 8 shows array data structures 800 for storing the elements of the Knowledge Graph. The entities are the nodes and edges of the Knowledge Graph. In an example embodiment the nodes N1 806, N2 808 . . . Nn 810 are stored in array 802. Further, the edges E1 806, E2 808 . . . En 810 are stored in array 804. The array data structure enables optimal storage and retrieval of the nodes and edges of the Knowledge Graph. In an alternate embodiment the arrays can be stored as JSON format files.

In an another embodiment, several data structures may be used for storing the nodes and edges of a Knowledge Graph, depending on the specific requirements of the application.

Adjacency List: An adjacency list is a list of nodes, where each node has a list of its adjacent nodes. This data structure is often used for sparse graphs, where the number of edges is much smaller than the number of nodes. It is memory-efficient and allows for efficient traversal of the graph.

Adjacency Matrix: An adjacency matrix is a two-dimensional array that represents the edges between nodes. The rows and columns represent the nodes, and the values in the matrix indicate whether there is an edge between two nodes or not. This data structure is often used for dense graphs, where the number of edges is close to the maximum possible number of edges. It allows for efficient access to any edge in the graph.

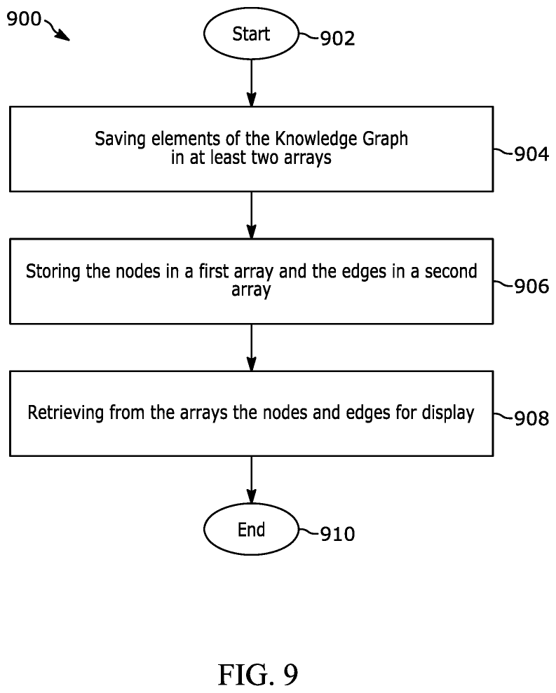

FIG. 9 illustrates a flow diagram of method 900 for saving and storing nodes and edges of a Knowledge Graph in arrays. It will be understood that each block of the flow diagram of the method 900 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 900 illustrated by the flowchart diagram of FIG. 9 is for saving and storing nodes and edges of a Knowledge Graph in arrays. Fewer, more, or different steps may be provided.

The method 900 starts at step 902. At step 904 the elements of the Knowledge Graph, nodes and edges are stored in array data structures. Particularly, the nodes and edges are stored in separate arrays in step 906.

When prompted for display at step 908, the Knowledge Graph is rendered by retrieving the nodes and edges from the array data structures.

An array is a data structure that stores a collection of elements of the same data type in contiguous memory locations. In other words, an array is a sequential collection of elements, where each element can be accessed using an index or a position in the array.

Arrays are commonly used in programming to store and manipulate collections of data, such as lists of numbers, strings, or objects. They are widely supported in most programming languages, including C, Java, Python, and JavaScript.

The elements in an array are typically of a fixed size and data type. Arrays can be either one-dimensional or multi-dimensional, where a multi-dimensional array is essentially an array of arrays.

Arrays provide several advantages, such as efficient random access to elements, predictable memory allocation, and support for efficient iteration using loops. However, they also have some limitations, such as fixed size and difficulty in adding or removing elements once the array is created.

In some example embodiments, a computer programmable product may be provided. The computer programmable product may comprise at least one non-transitory instructions that when executed by a computer, cause the computer to execute the method 900.

In an example embodiment, an apparatus for performing the method 900 of FIG. 9 above may comprise a processor (e.g., the processor 202) configured to perform some or each of the operations of the method 900. The processor may, for example, be configured to perform the operations (902-910) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (902-910)) may comprise, for example, the processor 201 which may be implemented in the system 200 and/or a device or circuit for executing instructions or executing an algorithm for processing information as described above.

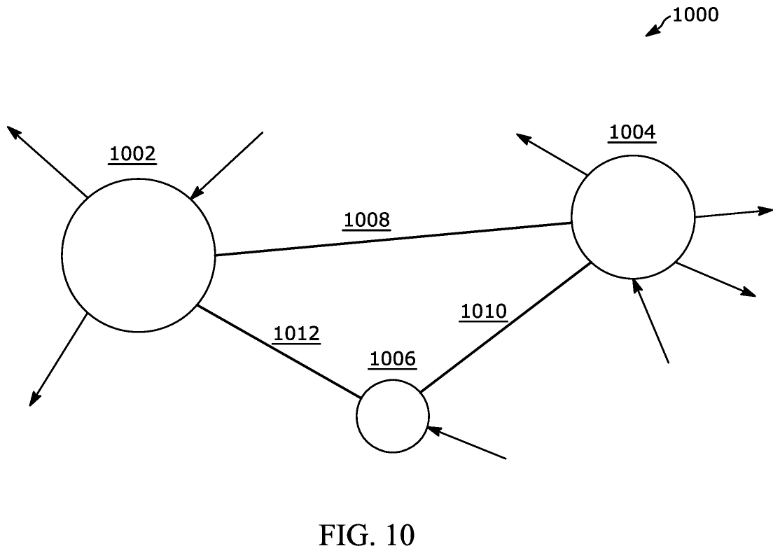

FIG. 10 shows a display of nodes and edges in a Knowledge Graph in an aesthetic manner 1000.

The nodes of the Knowledge Graph are allocated weights proportional to importance or centrality score.

In an embodiment the nodes that are important are considered central.

The centrality of a node in a graph refers to the importance or influence of that node in the overall structure of the graph. Centrality measures aim to quantify the extent to which a node is central, or in other words, how much it affects the graph's connectivity or flow.

There are several ways to define centrality of a node in a graph, and the choice of measure depends on the specific context and application. Some common centrality measures are mentioned below.

Degree centrality counts the number of edges incident to a node, i.e., the number of direct connections it has with other nodes. Nodes with high degree centrality are typically well-connected and serve as hubs in the network.

Betweenness centrality quantifies the extent to which a node lies on the shortest paths between other nodes. Nodes with high betweenness centrality play an important role in connecting different parts of the graph and facilitating communication and flow.

Closeness centrality calculates the inverse of the sum of the shortest path distances between a node and all other nodes in the graph. Nodes with high closeness centrality are close to many other nodes and can quickly transmit information or influence across the graph.

Eigenvector centrality takes into account the centrality of a node's neighbors and assigns higher centrality scores to nodes that are connected to other central nodes. Nodes with high eigenvector centrality are influential because they are connected to other important nodes.

In summary, centrality measures provide a way to quantify the importance of nodes in a graph, and they can help identify key players or bottlenecks in various types of networks, including social networks, transportation networks, and biological networks. In an example embodiment in the Knowledge Graph degree centrality may be used.

In an example embodiment, as shown in FIG. 10, the nodes 1002, 1004 and 1006 are in the descending order of importance. In a Knowledge Graph, the displayed size of the node is larger for a node with a higher importance.

A set of weights are allocated to each node in the Knowledge Graph. The allocated weights are proportional to their importance score.

The display of the Knowledge Graph proceeds by placing the nodes with the highest weight farthest from each other.

In an example embodiment, the distance 1008 between node 1002 and node 1004 is greater than the distance 1012 between node 1002 and node 1006. Also, the distance 1008 is greater than distance 1010 which is the distance between node 1004 and node 1006. In another embodiment, the placement is repeated multiple times for each node.

Displaying a Knowledge Graph with all nodes properly spread out may be aesthetically challenging, especially for large graphs with many nodes and edges. However, there are several techniques and algorithms that can be used to automatically lay out the graph in a way that is aesthetically pleasing and easy to understand. Here are some approaches to consider.

Force-directed layout: This approach uses physics-based simulation to lay out the nodes in the graph, where nodes repel each other. This results in a layout that tries to minimize the number of overlapping edges and nodes.

The force directed layout algorithm may be the baseline of the layout and any other modifications/conditions may be applied on top of this.

A force-directed graph is a type of layout algorithm where nodes of the graph are positioned based on forces between them. The forces can be modeled as attractive forces between connected nodes and repulsive forces between all nodes, with the goal of achieving a layout where nodes with strong connections are closer together and nodes with weak connections are farther apart. In principle, all nodes of a graph push each other away. And, the nodes that are joined by an edge will attract each other. Therefore, any two nodes will repulse each other and this repulsion force will be equal for all pairs of nodes, connected or not. For example, in an edgeless graph, all the nodes would be spaced out equally.

Alternatively for connected nodes, the length of every edge is minimized, as the very existence of the edge causes the two nodes it connects to be attracted to each other.

In another embodiment, a Fast Compound Spring Embedder (FCoSE) layout is used. FCoSE algorithm is a variation of force directed layout algorithm. specifies certain parameters that may be used to further fine-tuned to specific requirements.

Following are some of the parameters of interest amenable for tuning.

Ideal edge length: The ideal edge length parameter determines the optimal distance between connected nodes. A higher ideal edge length value makes the edges longer, which increases the distance between connected nodes. Conversely, a lower ideal edge length value makes the edges shorter, which decreases the distance between connected nodes.

Node repulsion: The node repulsion parameter determines how much the nodes repel each other. A higher node repulsion value makes the nodes more repulsive, which means it will push other nodes farther apart. Conversely, a lower node repulsion value makes the nodes less repulsive, which means it will be closer together with other nodes.

Further possible modifications based on weights are as follows:

Edge weights: Using the ideal edge length parameter, the length of the edge may be manipulated based on weights.

In an example embodiment, nodes with a higher degree of connections are pushed further away from each other to avoid overlap of dense clusters.

Node weights: Node weights may be used to influence the node repulsion parameter. Setting the node repulsion to be inversely proportional to the weight would allow nodes with higher weights to be in a more crowded area. Furthermore, setting node repulsion to be directly proportional to the weight may cause a high weightage node to be more isolated with all the nodes around it pushed far away. Hierarchical layout: This approach organizes the nodes in a hierarchical structure, where nodes are grouped based on their relationships or properties. This can make the graph easier to understand, especially if there are multiple levels of relationships or hierarchy in the graph.

Radial layout: This approach places the nodes in a circular or radial pattern, with nodes organized around a central node or theme. This can be useful for graphs with a central topic or concept.

Grid layout: This approach organizes the nodes in a grid pattern, with nodes aligned in rows and columns. This can be useful for graphs with a simple structure and a regular pattern.

Layered layout: This approach organizes the nodes into layers, with each layer representing a different level or category of nodes. This can be useful for graphs with a hierarchical or tree-like structure.

In addition to these techniques, it's important to provide tools for users to interact with the layout, such as zooming in and out, panning, and filtering nodes and edges. By combining these techniques and providing user interactivity, it is possible to display a Knowledge Graph with all nodes properly spread out in a way that is both aesthetically pleasing and easy to understand.

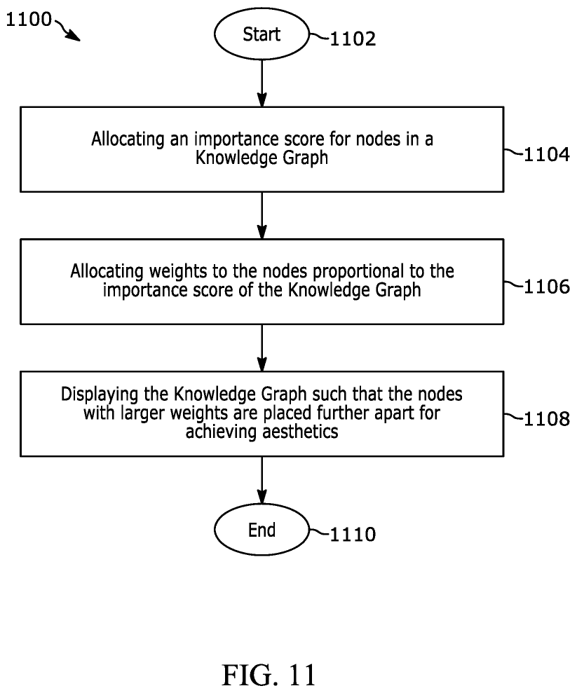

FIG. 11 illustrates a flow diagram for a method 1100 displaying nodes of a Knowledge Graph where nodes of higher importance are located further from each other in the display. It will be understood that each block of the flow diagram of the method 1100 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 1100 illustrated by the flowchart diagram of FIG. 11 is for displaying nodes of a Knowledge Graph where nodes of higher importance are located further from each other in the display. Fewer, more, or different steps may be provided.

Displaying a Knowledge Graph aesthetically can help make the knowledge Graph easier for users to understand and interact with the graph. Below are some ways on how to aesthetically display a Knowledge Graph:

Use a clear and consistent layout: The layout of the Knowledge Graph may be clear and consistent, with a logical hierarchy that reflects the relationships between nodes and edges. For example, nodes that are related may be positioned closer together, and edges that represent similar types of relationships may have a consistent style.

Use colors and icons to highlight nodes and edges: Colors and icons can be used to highlight important nodes or edges in the graph, making them easier to identify and distinguish from other nodes and edges. For example, a user may use a different color for nodes that represent entities or concepts, and a different color for nodes that represent relationships or properties.

Provide clear labels and tooltips: Labels and tooltips may be used to provide additional information about nodes and edges in the graph, such as names, types, or descriptions. Labels should be clear and concise, and tooltips should provide more detailed information when the user hovers over a node or edge.

Use animations and transitions to show changes in the graph: Animations and transitions may be used to show changes in the graph over time, such as adding or removing nodes or edges. This may help users better understand the dynamics of the graph and how it is evolving over time.

Provide interactivity and filtering options: Interactivity and filtering options can make the Knowledge Graph more engaging and useful for users. For example, users could filter the graph based on certain criteria to see different levels of detail.

Overall, the key to aesthetically displaying a Knowledge Graph is to make it visually appealing, easy to understand, and interactive, while still conveying the complex relationships and structures within the graph.

At step 1104, importance scores are computed and allocated for every node of a Knowledge Graph.

Further, weights are allocated to the nodes at step 1106, wherein the weights are proportional to their importance score.

The method 1100 starts at step 1102.

The Knowledge Graph is displayed in such a way that the nodes with higher weights are placed further apart at step 1108.

In some example embodiments, a computer programmable product may be provided. The computer programmable product may comprise at least one non-transitory instructions that when executed by a computer, cause the computer to execute the method 1100.

In an example embodiment, an apparatus for performing the method 1100 of FIG. 11 above may comprise a processor (e.g., the processor 202) configured to perform some or each of the operations of the method 1100. The processor may, for example, be configured to perform the operations (1102-1110) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1102-1110) may comprise, for example, the processor 201 which may be implemented in the system 200 and/or a device or circuit for executing instructions or executing an algorithm for processing information as described above.

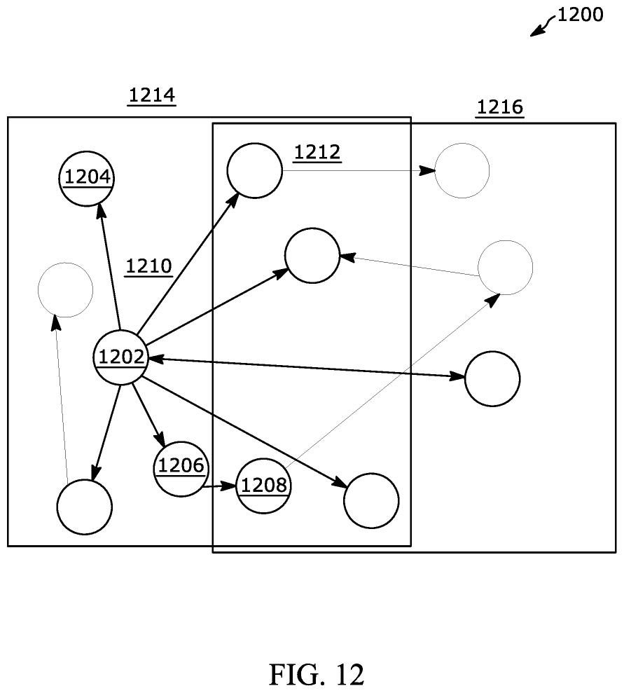

FIG. 12 illustrates a panning tool for visually manipulating a Knowledge Graph. This panning tool is particularly useful for displaying a large Knowledge Graph.

A panning tool is a useful feature for navigating a large Knowledge Graph, allowing users to move the graph view horizontally and vertically to see different parts of the graph. Below are some steps on how to use a panning tool for a Knowledge Graph:

Identify the panning tool: The panning tool is typically represented by a hand icon, which may be found in the toolbar or menu of the graph visualization software or application.

Click and drag the panning tool: To use the panning tool, click and hold the left mouse button while the hand icon is selected. Drag the mouse in the direction you want to move the graph view. The graph view should move in the same direction as the mouse movement.

Release the mouse button: Once the user has moved the graph view to the desired position, release the mouse button to stop panning.

Repeat as necessary: the user may continue to use the panning tool to navigate to different parts of the graph. Simply click and drag the hand icon in the direction the user want to move.

Some graph visualization software may have additional features or options for panning, box select etc., such as keyboard shortcuts or touchpad gestures.

In an example embodiment, as in FIG. 12 the Knowledge Graph is visible in the panning window 1214. A user, with help of the panning tool, can shift to the display of panning window 1216.

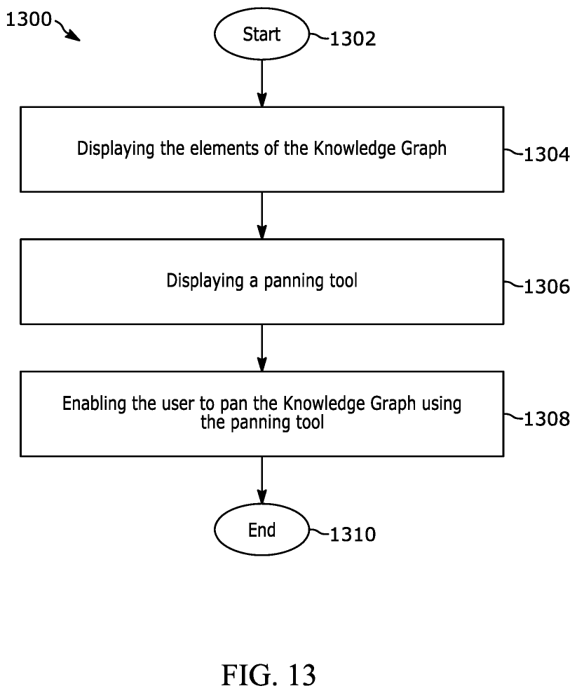

FIG. 13 shows a flow diagram of method 1300 enabling a user to pan the Knowledge Graph during display. The method 13 starts at step 1302. At step 1304 the Knowledge Graph is displayed. It will be understood that each block of the flow diagram of the method 13 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 1300 illustrated by the flowchart diagram of FIG. 13 for enabling a user to pan the Knowledge Graph during display. Fewer, more, or different steps may be provided.

Further, a panning tool is displayed to a user at step 1306. The user may pan the display of the Knowledge Graph using the panning tool at step 1308.

In some example embodiments, a computer programmable product may be provided. The computer programmable product may comprise at least one non-transitory computer-readable storage medium having stored thereon computer-executable program code instructions that when executed by a computer, cause the computer to execute the method 1300.

In an example embodiment, an apparatus for performing the method 1300 of FIG. 13 above may comprise a processor (e.g., the processor 202) configured to perform some or each of the operations of the method 1300. The processor may, for example, be configured to perform the operations (1302-1310) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1302-1310) may comprise, for example, the processor 202 which may be implemented in the system 200 and/or a device or circuit for executing instructions or executing an algorithm for processing information as described above.

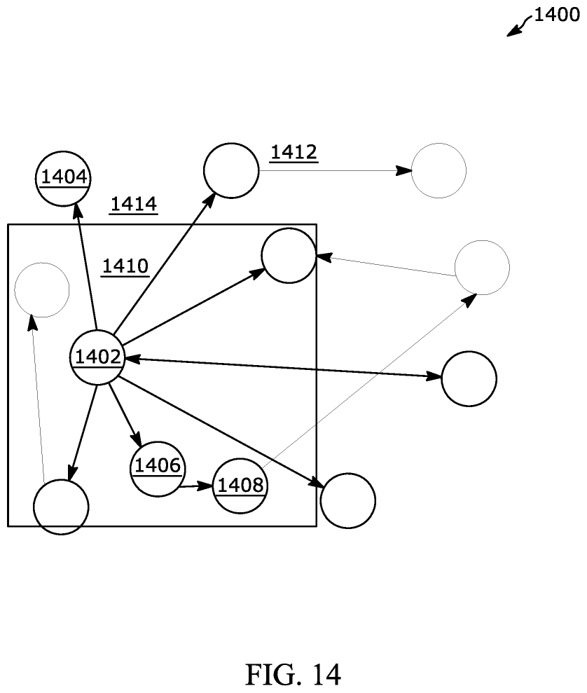

FIG. 14 illustrates a box select tool of the Knowledge Graph. A user is provided with a box select tool using which the user may create a window 1414 in the displayed Knowledge Graph. The window 1414 is essentially smaller than the original display.

A box select interface is a useful feature for exploring and analyzing a Knowledge Graph. Below are some steps on how to use a box select and zoom interface:

Identify the box select tool: The box select tool is typically represented by a rectangular icon, which may be found in the toolbar or menu of the graph visualization software or application.

Select the box select tool: Click on the box select tool to activate it.

Draw a box around the nodes the user wants to select: Click and drag the mouse to draw a rectangle around the nodes the user wants to select. The nodes and edges connected to the selected nodes within the box may be highlighted or displayed in a different color.

By using the box select tool, the user may quickly and easily focus on specific parts of the graph for analysis or exploration. Some graph visualization software may have additional features or options for box select, such as the ability to select multiple boxes or to adjust to fit to display size.

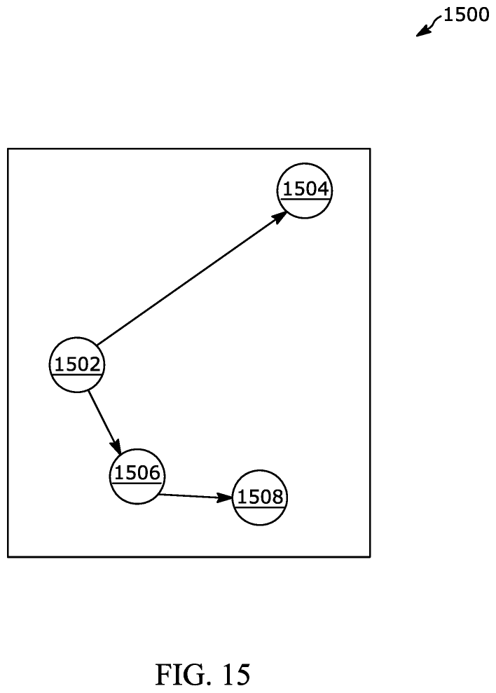

FIG. 15 illustrates the operation of the box select tool of the Knowledge Graph by selecting the nodes within the box and hiding the nodes outside the box. Further, FIG. 15 is a temporal successor of FIG. 14, after the box select tool is applied. In an example embodiment the window 1414 is magnified to fit the display screen.

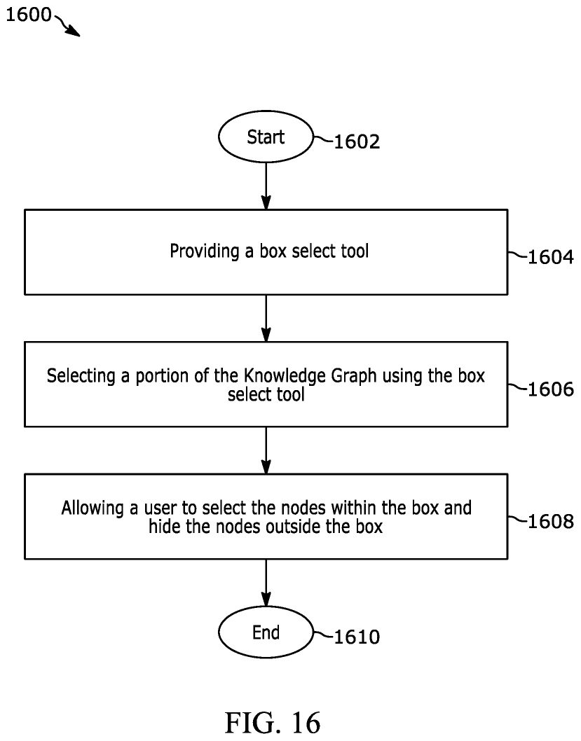

FIG. 16 illustrates a flow diagram of a method 1600 for providing a box select tool that allows the user to select a subset of nodes. The method 1600 starts at step 1602. It will be understood that each block of the flow diagram of the method 1600 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 1600 is illustrated by the flowchart diagram of FIG. 16 for providing a box select tool that allows the user to select the nodes within the box and hide the nodes outside the box the display. Fewer, more, or different steps may be provided.

At step 1604, a box select tool is provided to a user. A user selects a portion of the displayed Knowledge Graph using the box select tool at step 1606. At step 1608 the user is allowed to select the nodes within the box and hide the nodes outside the box the display of the Knowledge Graph. The method stops at step 1610.

In some example embodiments, a computer programmable product may be provided. The computer programmable product may comprise at least one non-transitory computer-readable storage medium having stored thereon computer-executable program code instructions that when executed by a computer, cause the computer to execute the method 1600.

In an example embodiment, an apparatus for performing the method 1600 of FIG. 16 above may comprise a processor (e.g., the processor 202) configured to perform some or each of the operations of the method 1600. The processor may, for example, be configured to perform the operations (1602-1610) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1602-1610) may comprise, for example, the processor 202 which may be implemented in the system 200 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method for displaying a Knowledge Graph comprising:
receiving a selection of a first element by a user, in the Knowledge Graph;
receiving a selection of a second element by the user, in the Knowledge Graph;
providing a user interface (UI) component; and
displaying the first element on selecting the UI component by the user.

2. The method of claim 1, further comprising occluding the second element.

3. The method of claim 1 further comprising receiving selection of a third element and a fourth element by the user, in the knowledge graph.

4. The method of claim 2, further comprising displaying the first element, the second element, the third element and the fourth element, on selecting the UI component in reverse order of selection.

5. The method of claim 1, further comprising saving a state of display of the knowledge graph on closing display of the Knowledge Graph.

6. The method of claim 5, further comprising restarting the display of the Knowledge Graph and rendering the saved display of the Knowledge Graph.

7. The method of claim 1, further comprising saving elements of the Knowledge Graph in at least two arrays.

8. The method of claim 7, wherein the elements comprise nodes and edges.

9. The method of claim 8, wherein the nodes are stored in a first array and the edges are stored in a second array.

10. The method of claim 3, further comprising;
allocating a first weight, a second weight, and a third weight to the first element, the second element and the third element respectively of the Knowledge Graph, wherein the first weight is lesser than the second weight and the third weight is greater than the second weight; and
displaying the first element, the second element and the third element, wherein display distance between the first element and the second element is greater than display distance between the first element and the third element.

11. The method of claim 1, further comprising enabling the user to pan the Knowledge Graph during display.

12. The method of claim 1, further comprising providing a box select tool that allows the user to select a subset of nodes of the Knowledge Graph.

13. A system comprising at least a processor and computer executable instructions, that when executed by the hardware processor, cause the system to display Knowledge Graph comprising:
receiving a selection of a first element by a user, in the Knowledge Graph;
receiving a selection of a second element by the user, in the Knowledge Graph;
providing a user interface (UI) component; and
displaying the first element on selecting the UI component by the user.

14. The system of claim 13, further comprising occluding the second element.

15. The system of claim 13 further comprising receiving selection of a third element and a fourth element by the user, in the knowledge graph.

16. The system of claim 14, further comprising displaying the first element, the second element, the third element and the fourth element, on selecting the UI component in reverse order of selection.

17. The system of claim 13, further comprising saving a state of display of the knowledge graph on closing display of the Knowledge Graph, and on restarting the display of the Knowledge Graph, rendering the saved display of the Knowledge Graph.

18. The system of claim 1, further comprising saving elements of the Knowledge Graph in at least two arrays, wherein the elements comprise nodes and edges and the nodes are stored in a first array and the edges are stored in a second array.

19. The system of claim 15, further comprising;
allocating a first weight, a second weight, and a third weight to the first element, the second element and the third element respectively of the Knowledge Graph, wherein the first weight is lesser than the second weight and the third weight is greater than the second weight; and
displaying the first element, the second element and the third element, wherein display distance between the first element and the second element is greater than display distance between the first element and the third element.

20. A computer programmable product comprising a non-transitory computer readable medium having stored thereon computer executable instruction which when executed by one or more processors, cause the one or more processors to carry out operations for displaying a Knowledge Graph at a client device, the operations comprising:
receiving a selection of a first element by a user, in the Knowledge Graph;
receiving a selection of a second element by the user, in the Knowledge Graph;
providing a user interface (UI) component; and
displaying the first element on selecting the UI component by the user.
